(19) United States
(12) Patent Application Publication
(10) Pub. No.: US 2018/0297050 A1
(43) Pub. Date: Oct. 18, 2018

(54) Nozzle Apparatus

(71) Applicant: Rigdeluge Global Limited, Aberdeenshire (GB)

(72) Inventor: Ian Garden, Aberdeenshire (GB)

(21) Appl. No.: 15/766,396

(22) PCT Filed: Oct. 7, 2016
(86) PCT No.: PCT/GB2016/053124

§ 371 Date: Apr. 6, 2018

(30) Foreign Application Priority Data
Oct. 7, 2015 (GB) 1517760.3

(51) Int. Cl. B05B 15/40; A62C 31/02

(52) U.S. Cl. CPC B05B 15/40; A62C 31/02

(57) ABSTRACT

A nozzle apparatus comprising a nozzle and a cap. The nozzle has a tube extending from a first end to a second end. The tube has a bore with an internal cross-sectional area. There is an inlet to the tube; and an outlet from the tube, the outlet having an outlet cross-sectional area. The nozzle has a plurality of further inlets in the tube between an outside thereof and the bore. The cap comprises an attachment means for attachment to the inlet to the tube, and comprises a cap inlet.

This invention relates to a nozzle apparatus particularly but not exclusively for use in firefighting or fire suppression and which is in use connected to a pipeline.

Fluid flow systems, such as sprinkler systems are widely used in onshore and offshore installations, such as oil and gas platforms, to contain or suppress fire. During operation of the sprinkler system, it is likely that scale, debris and other pollutants will build up and become a problem. Scale is typically formed by the precipitation of mineral compounds from water, such as calcium carbonate or calcium sulphate, due to pressure and/or temperature changes in the pipeline. Corrosion in pipelines can build up along the inner wall of pipe and also results in debris entering the system. Marine growth can also cause blockage problems. Salts can also crystallise and cause blockage problems. The by-products of salt water as a delivery fluid are also a problem and it is thought that this has contributed to firefighting/deluge systems offshore failing where there has been loss of life, asset and indeed oil spills.

It is a regular occurrence for nozzles of sprinkler systems to block due to this build-up, and this can cause the whole system to become redundant. If such nozzles become blocked, the ability of the sprinkler system to contain or suppress a fire could be severely impeded. This could hinder the safe escape of platform personnel.

Other fluid flow systems such as burner heads can also suffer from a variety of debris which inhibits flow.

Debris can pose a problem if it is distributed out with the sprinkler system. Fluid is typically ejected from the exit point at high velocities and any debris present can cause injury to personnel. It has been known to cut faces and has the potential to cause serious eye injuries.

WO2014/009713 describes a nozzle apparatus with an entry segregator 22 having an axial passage 12. Slots 25 in the entry segregator 22 provide additional filtration capacity to other components described therein.

Whilst generally satisfactory, the inventor of the present invention has developed an improved nozzle apparatus.

According to a first aspect of the present invention, there is provided a nozzle apparatus comprising a nozzle and a cap, the nozzle having:
a tube extending from a first end to a second end, the tube having a bore with an internal cross-sectional area;
an inlet to the tube;
an outlet from the tube, the outlet having an outlet cross-sectional area;
a plurality of further inlets in the tube between an outside thereof and the bore;

the cap comprising an attachment means for attachment to the inlet to the tube, and a cap inlet.

In at least some examples, the cross-sectional area of the cap inlet is less than the outlet cross-sectional area.

This is in direct contrast to WO2014/009713 (supra) where debris can enter through a large inlet and central passage 12 and is encouraged to do so, in order to be directed to a debris pot 40 within the nozzle apparatus. In the present invention by contrast, the cross-sectional area of the cap inlet may be less than the outlet cross-sectional area. As there is no debris pot, service requirements are reduced.

The nozzle may comprise a deflector coaxial with the tube; and a connecting means, connecting the tube to the deflector.

The inventor of the present invention has noted that it is difficult to manufacture a nozzle with a filter where the inlet is smaller than the outlet because the outlet bore cannot be drilled from the outlet end because of the position of the co-axial deflector, and a larger diameter outlet cannot be drilled through the smaller diameter inlet. Whilst the parts can be manufactured separately with a smaller inlet, and then joined together, this complicates and adds expense to the manufacturing process.

Accordingly the solution where the connecting means, such as arms, and ideally including the deflector too, are preferably formed as a single piece with the tube, is the incorporation of a cap.

Thus, the tube and connecting means are normally formed as a one-piece item.

The cap may comprise a discrete component that is separate, and optionally separable, from the nozzle.

The cap may be releasable. The cap is normally sealed to the inlet to the tube such that fluid passage at the tube's inlet (opposed to through the further inlets) is through the cap inlet only.

The cap may be added to the nozzle prior to attachment of the nozzle or nozzle apparatus to the pipeline.

The cap may be retrofitted to the nozzle. The cap may be added to the nozzle after the nozzle has been installed or attached, such as in or to a pipeline. In such examples, the nozzle may be temporarily removed from the pipeline to add the cap to the nozzle. In at least some examples, the cap may be replaced with a similar and/or a different cap. In at least some examples, the cap may be added to the nozzle when or after the nozzle already comprises the deflector. For example, the cap may be added to the nozzle where the nozzle is formed with an integral deflector.

The cap inlet cross-sectional area is smaller than the outlet cross-sectional area of the nozzle. Debris too large for the cap inlet or further inlets, is thus maintained outside of the nozzle apparatus and any debris which is small enough to enter through the cap inlet or the further inlets will not be large enough to block the outlet.

A portion of the cap inlet is normally provided in a centre of the cap. For example, it may be a circular hole having a diameter of, for example, from 1-5 mm, or 2-4 mm.

The cap inlet may alternatively or additionally include at least one, normally two, slots. The cap inlet slots may be provided in a cross-arrangement, and they may cross each other, optionally in the centre. Optionally a circular inlet is provided in the centre as well as having one, two or more slots in the cap.

At least a portion of the slots extend through the cap, such that fluid may travel from the pipeline in use into the tube through the slots in the cap. However, a portion of the slots, especially towards their radially outward extent, may not extend through the cap.

The cap may be received within the nozzle inlet, such as within the internal bore of the tube of the nozzle. The cap may be received within the nozzle inlet such that an external surface of the cap does not project beyond an external surface of the nozzle. For example, the exterior of the cap may be flush with the exterior of the nozzle.

The cap may be retrofittable, such as to be retrofitted to an existing or previously-installed nozzle apparatus.

In at least some examples, the cross-sectional area of the cap inlet may be equal to or greater than the outlet cross-sectional area. For example, the nozzle apparatus may comprise a nozzle similar to WO2014/009713, the contents of which are incorporated herein by reference. Adding the cap, such as by retrofitting, may enable a change in nozzle apparatus inlet properties. For example, the size of debris permitted to enter the tube may be varied, such as to reduce the size of debris that can enter the tube. Accordingly, the amount of debris that accumulates in a debris pot may be at least reduced, such as to reduce, or even eliminate, service requirements to inspect or empty the debris pot. The cap may be removable and optionally interchangeable, such as with a replacement cap. The replacement cap may comprise different properties, such as a different cap inlet. Accordingly the cross-sectional area and/or form of the cap inlet may be varied. There may be provided an array of caps, the array comprising caps with different cap inlets.

The nozzle apparatus, normally the cap, includes cap attachment means. The attachment means may comprise an inter-engaging arrangement. The attachment means may comprise a push-on attachment means. The attachment means may comprise an interference fit. The attachment means may comprise a snap-fit or snap-on attachment means. The attachment means may be a plurality of resilient arms extending from the cap, such as the periphery of the cap, each optionally including shoulders for engagement in a suitably formed recesses, such as the further inlets. The arms may have a tapered end. They may be spaced apart, especially in a circular arrangement, such that when placed over the inlet of the tube, they resiliently deform and then snap-fit into place when aligned with a recess in the tube, the shoulders engage therein. There is normally more than two arms, optionally more than three such as four or six. Normally there is less than ten or less than eight.

Alternatively the attachment means may be different, such as a threaded connection.

The cap may be tapered and especially dome shaped. That is, the centre of the cap may extend longitudinally further than an outer portion of the cap. In this way, debris is in use directed towards an outside of the tube, where it is less likely to be drawn into the nozzle and potentially block it downstream.

A central region of the cap may be flat in surface and an outer region tapered and frusto-dome shaped.

The nature (e.g. size, orientation, shape) of the deflector can vary depending on the specific performance sought from the nozzle apparatus. It may include a splitter portion, which may be in the shape of a disc, or inverted cone for example, and may further include vanes or tines extending radially. The orientation of the deflector may be varied, for example in a plane of ninety degrees to the main axis of the tube.

In at least some examples, the deflector may comprise a spiral impingement surface, such as with a helix, pigtail or corkscrew coaxially positioned and connected to the tube by the connecting means.

The nozzle apparatus may comprise an insert, such as for attachment at or to the outlet. The insert may comprise the deflector. In at least some examples, the insert may determine a spray property, such as a spray angle and/or cone shape. The insert may be attachable to the tube, such as by a screwthread, inter-engaging coupling arrangement, bayonet-fitting, or other attachment means, at, around, or particularly in, the outlet from the tube.

The cap may be made from a variety of different materials, such as plastic and metal. It may be the same material as the nozzle.

The further inlets normally have a minimum cross-sectional dimension (e.g. width), which is smaller than a minimum dimension of the outlet from the tube.

Thus any debris small enough to pass through the further inlets will be too small to block said outlet.

The further inlets may be slots or may be more circular holes for example. When slots, their smaller dimension, for example, their width is the minimum dimension, such as 1 mm wide. When the slots include circular holes, the diameter of the holes, such as 1 mm diameter is the minimum dimension, which is less than said outlet's minimum dimension.

The number of further inlets depends on the diameter of the nozzle. There is normally at least 8 further inlets, and for a 0.5″ diameter nozzle, there are normally up to 20 further inlets.

Three (preferably two) of the further inlets can provide the same cross-sectional area as the outlet, therefore even with some of the further inlets blocked, flow to the outlet can still be maintained at the appropriate rate.

The inlet to the tube is normally provided at the first end of the tube. However, the (normally circular) inlet may be provided on a side face of the tube (in addition to the further inlets) and the cap attached to such a side face.

For embodiments where the further inlets are slots, they may extend generally parallel (+/−10 degrees) to the (normally longitudinal) direction from the first to the second end.

For embodiments especially according to the first aspect of the invention, the further inlets normally have a width of 1-3 mm or 1.5-2.5 mm. The spacing between the further inlets is normally between 50% and 150% larger than the width of the further inlets. For example the further inlets may be 1 mm width, and spaced apart by 2 mm.

The length of the slots can vary depending on the application of the nozzle apparatus e.g. the size of a pipeline to which it may be attached but is normally at least 1.5 cm, optionally at least 2 cm, or normally for larger pipes, more than 3 cm. They may extend up to 10 cm or up to 8 cm, although this largely depends on the size of the pipeline to which they are attached.

Alternatively, the slots may extend for more than 4 cm and optionally up to 6 cm.

The further inlets may extend in a portion of the tube for up to 99%, 75% or up to 50% of the length of the tube. The further inlets may extend for a portion of the tube between the first end and a wider outer diameter portion of the tube. The further inlets may extend for up to 99%, 75% or up to 50% of the length of the tube between the first end and up to the wider diameter portion of the tube.

The further inlets may extend for more than 25% of the length of the tube or more than 33%. They may extend for more than 33%, preferably more than 50% the length of the tube between the first end and up to the wider diameter portion. Accordingly, a solid portion without further inlets may extend between the wider diameter portion and the further inlets, for more than 10% of the tube's length, optionally more than 20%.

The minimum dimension of the further inlets may be smaller than the cap inlet—for example, 1.5 mm in width and the cap inlet is 3 mm.

The width of the outlet may be much larger than the minimum dimension of the further inlets. It may be 2, 2.5 or 3 fold larger.

The cap inlet may have an area of 50-95% of the cross-sectional area of the area of the outlet, optionally 60%-85%.

The tube normally includes at least two portions having different outer diameters. A first portion, between the inlet and the second portion, and the second portion between the first portion and the outlet. The second portion normally is thus said wider diameter portion. It normally has a mounting means.

The nozzle therefore normally has a mounting means for mounting to a pipeline in use. This is often a threaded body, but may be a snap-fit connection or other suitable device. The threaded body may be provided on an outside of a portion of the tube.

The bore of the tube normally includes at least two sections of differing cross-sectional size. These normally are defined at the same longitudinal position along the tube as the first and second portions of differing outer diameter.

A first section of the tube, referred to as a chamber, is between the inlet at the first end and the second section. A second section of the tube, referred to as a channel, is between the first section and the outlet of the tube.

The chamber normally has a larger cross sectional area compared to the channel.

The chamber normally has a larger cross sectional area compared to the outlet cross-sectional area.

The channel normally has the same cross-sectional area compared to the outlet (+/−20%). Further it is normally larger cross sectional area than the cross-sectional area of the inlet 18.

The further inlets are normally provided between the chamber i.e. normally said first portion of the tube.

Whilst the dimensions can vary, the chamber may be 40 mm-100 mm in length.

The channel may be 5 mm-20 mm in length.

The internal cross-sectional area of the tube, chamber or channel is normally taken at the narrowest internal point in the tube, chamber or channel respectively.

Said internal cross-sectional area of each the tube, chamber and channel normally have a height to width ratio of at most 2:1, normally 1.5:1, 1.1:1 or equal i.e. 1:1.

Preferably therefore, the tube may be circular in cross-section. The tube normally extends longitudinally and has a central axis therein. The outlet may be at the second end.

The tube may be 45 mm-120 mm, optionally 60-100 mm in total.

The chamber is preferably of a cylindrical shape, as opposed to conical or frusto-conical. Therefore can provide full bore pressure to the outlet of the nozzle. Therefore, preferably at least 80% of the length of the chamber has the same cross-sectional area.

The channel is preferably of a cylindrical shape, as opposed to conical or frusto-conical. This also assist in providing appropriate flow rate and pressure to the outlet. Therefore, preferably at least 80% of the length of the channel has the same cross-sectional area.

Normally there is no more than one outlet (to atmosphere).

According to a third aspect of the invention, there is provided a pipeline apparatus comprising a pipeline, and the nozzle apparatus as described herein.

Thus the nozzle apparatus extends into the pipeline. In use, it can filter debris from entering which can mitigate the blockages or reduce the number of blockages, experienced downstream, such as in the nozzle apparatus.

A reducing bush may be used to size the nozzle apparatus into a suitable socket in the pipeline. For example, a 0.5″ nozzle may be added to a 1.5″ pipeline via a reducing bush.

Preferably the length of the tube, is longer, such that it extends beyond any reducing bush in use.

This is especially useful for nozzle apparatus installed at elbow and/or T-joints.

Various embodiments may have 50 to 100% of the area of the tube adjacent the reducing bush without further inlets, optionally more than 70% or more than 90%.

Alternatively, a weld-o-let fitting may be used.

The portion of the tube adjacent the reducing bush, or weld-o-let, is preferably substantially solid—the slots extending in a portion of the tube outwith this area. This can improve the mechanical mounting. For example, at least 75% of this area may be free from slots or at least 95%.

The nozzle apparatus may be added to an end of the pipeline, and extend therein, substantially parallel (+/−10 degrees) to the main longitudinal axis of the pipeline. Alternatively, it may be provided at an angle such as substantially at a right angle (+/−10 degrees) to the main longitudinal axis of the pipeline.

The pipeline may have an inner diameter from 0.5″ optionally more than 0.75″ or more than 1″. Certain embodiments may be up to 3.5″, up to 3″ or up to 2″.

Whilst the nozzle apparatus described herein may be suitable for a variety of applications which require clear flow of fluid, it is preferred for use in pipelines, especially as a nozzle apparatus for a pipeline. For example, a burner head for flaring oil or gas, water delivery lines, especially a sprinkler system for firefighting or fire containment.

According to a third aspect of the invention, there is provided a method of using the nozzle apparatus described herein for firefighting and/or fire containment.

Thus the nozzle apparatus described herein may be a sprinkler apparatus.

The firefighting and/or fire containment is often for open sprinkler systems, that is those exposed to the environment. Precipitation and moisture thus encourage rust and other deterioration of such an open system. Those in the marine environment, such as offshore sprinkler systems, are particularly prone to debris within pipework leading to nozzles because of the salt water environment which can further deteriorate the pipework. Salt water by-products can also block nozzles.

More generally, the invention also provides, a nozzle having:
a tube extending from a first end to a second end, the tube having a bore with an internal cross-sectional area;
an inlet to the tube;
an outlet from the tube, the outlet having an outlet cross-sectional area;
a plurality of further inlets in the tube between an outside thereof and the bore.

In use, it is preferred to add a cap to the inlet of the tube. The cap is preferably a cap as described herein.

Whilst the cap is added to the inlet of the tube, different caps with different dimensions may be easily interchanged.

The inlet may be positioned through the first end of the tube.

The nozzle may have a deflector coaxial with the tube; and a connecting means, connecting the tube to the deflector.

The invention also provides a method of manufacturing the nozzle described herein, including:
forming the tube and connecting means as a single piece item.

The further inlets, and other feature of the nozzle, may be machined or otherwise provided for the nozzle before or after the tube and connecting means are formed as a single piece item.

Normally the tube, connecting means and at least a portion of the deflector are formed as a single piece item.

Embodiments of the present invention will now be described, by way of example only, with reference to the accompanying figures, in which:

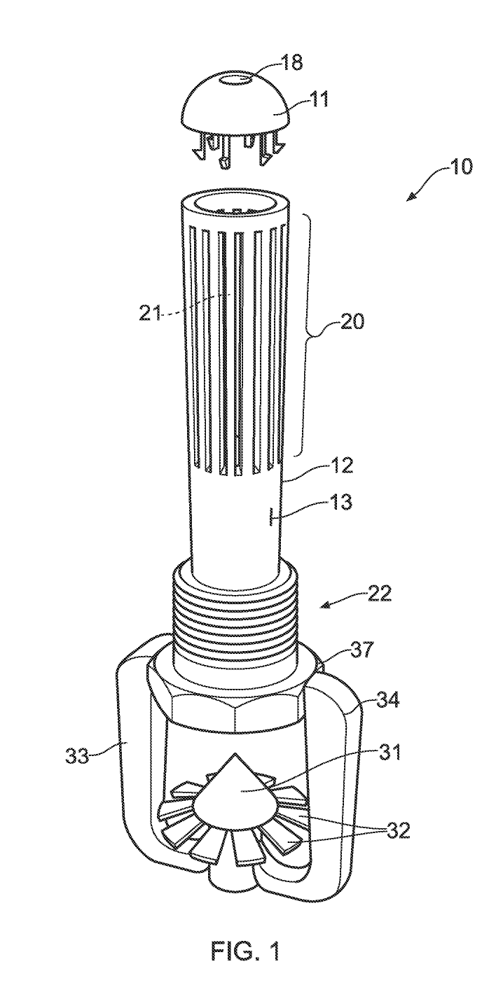

FIG. 1 shows a perspective exploded view of a first embodiment of a nozzle apparatus in accordance with one aspect of the present invention;

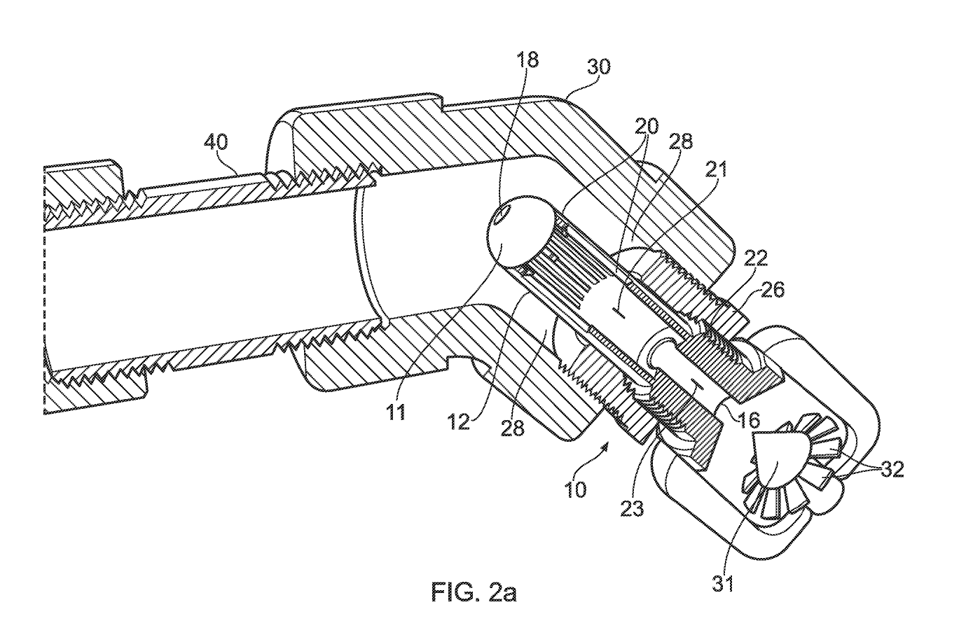

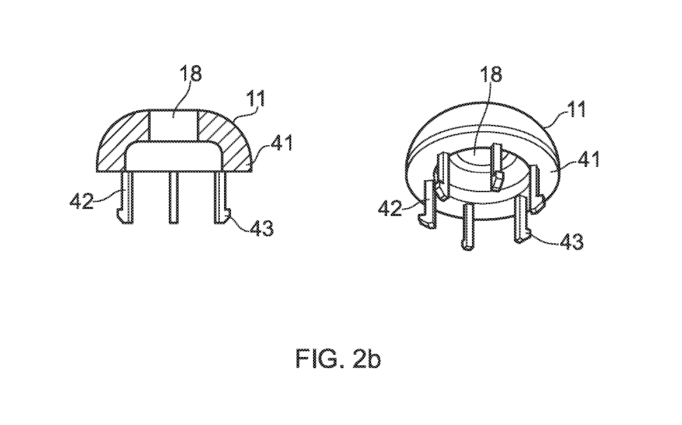

FIG. 2a shows a part cut-away perspective view of the FIG. 1 nozzle apparatus in an end of a pipeline;

FIG. 2b shows a cross-sectional view and a perspective view of the FIG. 2a cap;

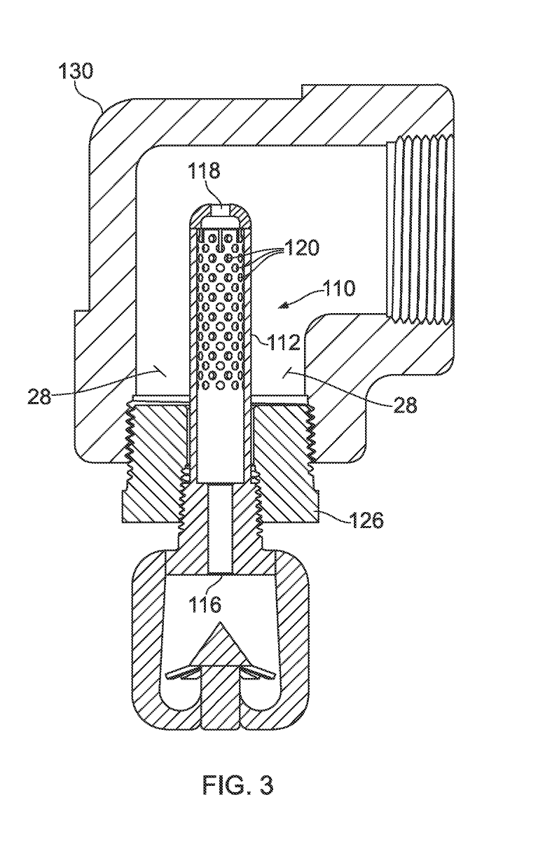

FIG. 3 shows a front view of a further embodiment of a nozzle apparatus attached to a pipeline by an elbow joint;

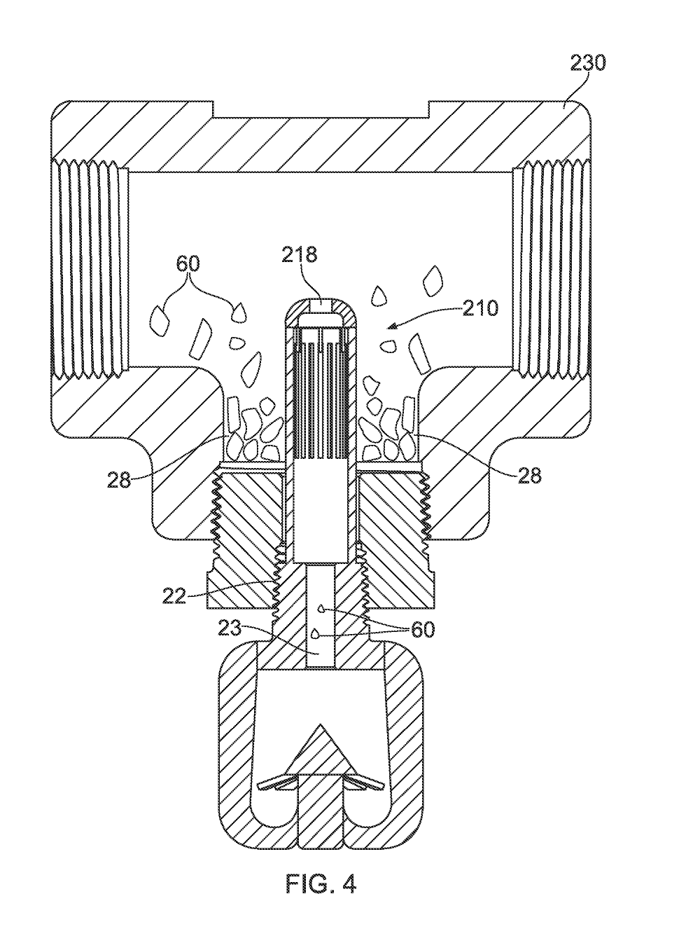

FIG. 4 shows a front view of a further embodiment of a nozzle apparatus connected to a pipeline via a T-joint;

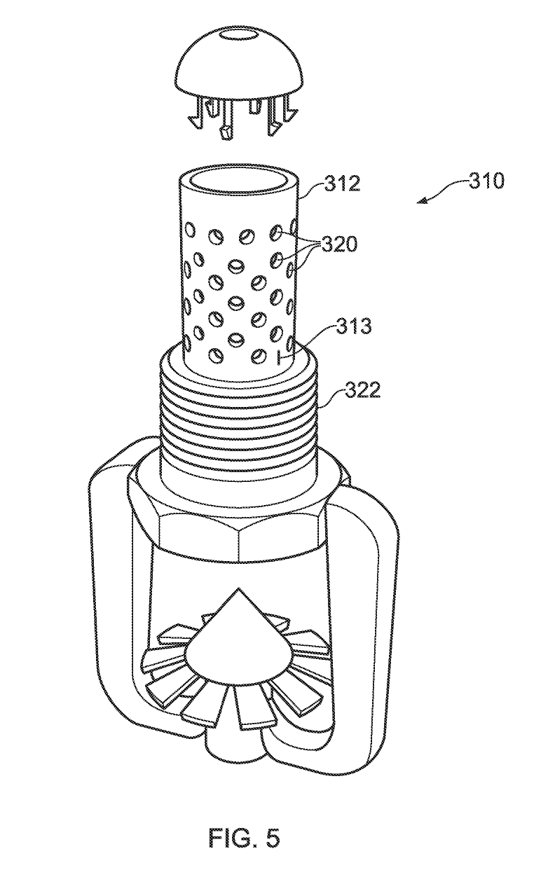

FIG. 5 shows a perspective exploded view of a further embodiment of a nozzle apparatus;

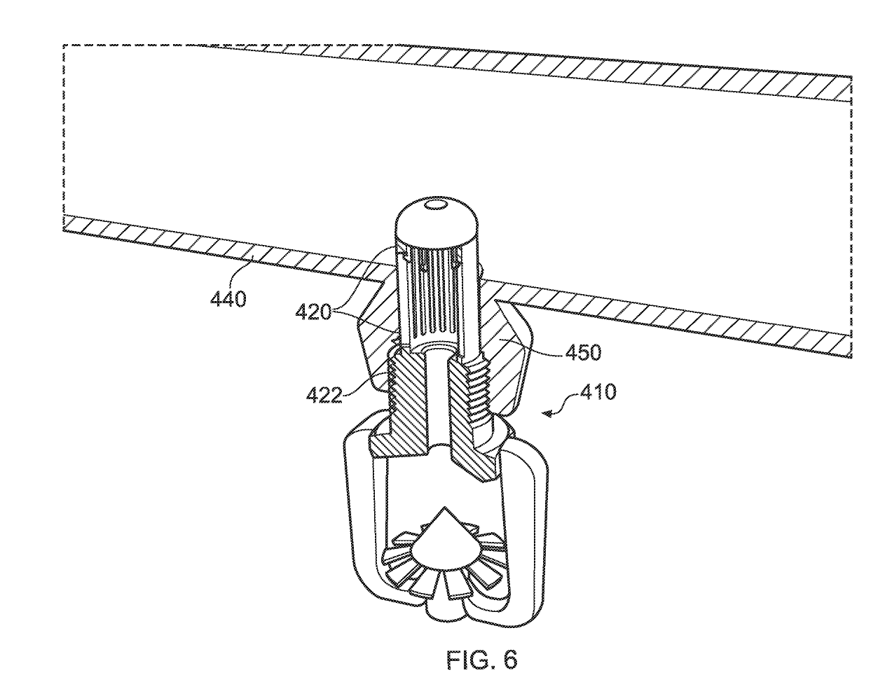

FIG. 6 shows a perspective view of a yet further embodiment of a nozzle apparatus arranged in a pipeline connected with a weld-o-let fitting;

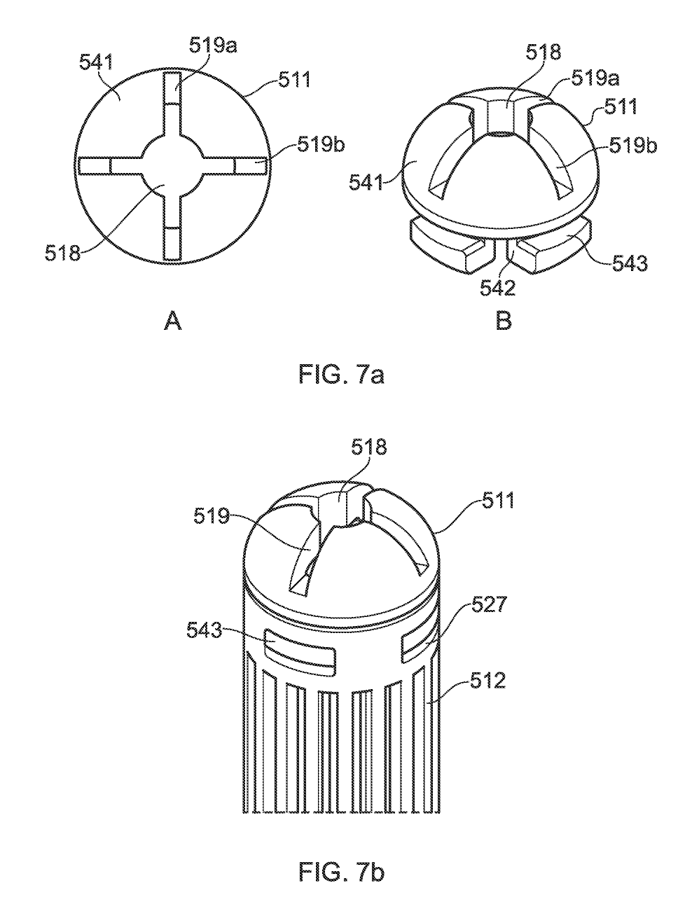

FIG. 7a shows a plan view and a perspective view of a cap in accordance with another aspect of the present invention; and

FIG. 7b shows a perspective view of the FIG. 7a cap attached to a tube;

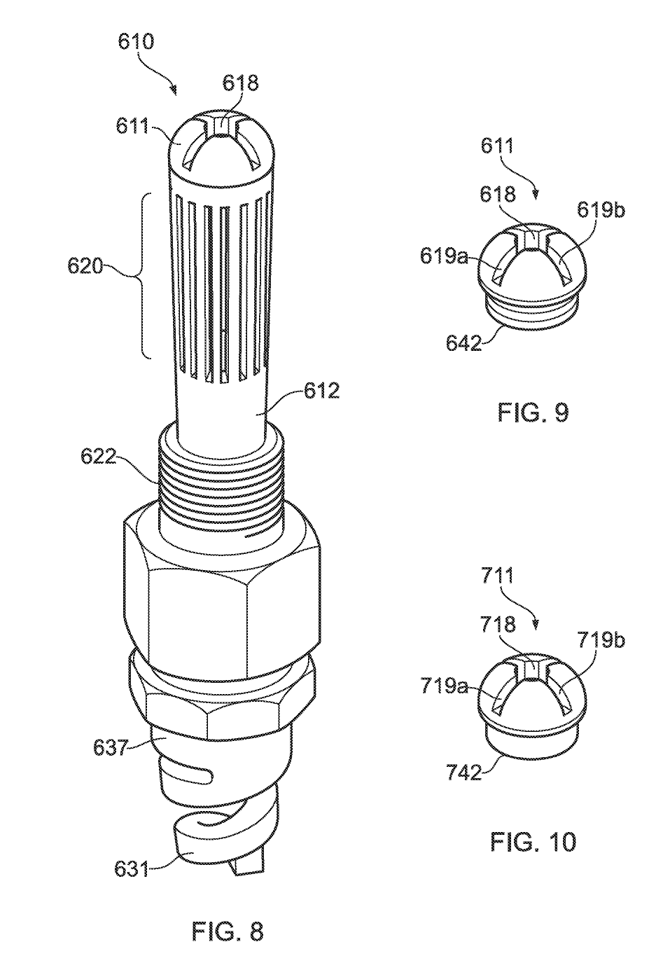

FIG. 8 shows a perspective view of a further embodiment of a nozzle apparatus;

FIG. 9 shows a perspective view of the cap of the apparatus of FIG. 8; and

FIG. 10 shows a perspective view of a further embodiment of a cap.

FIGS. 1, 2a and 2b show an embodiment of a nozzle apparatus 10 in accordance with one aspect of the present invention.

The nozzle apparatus 10 is a pendent-type nozzle formed from a tube 12 extending from a first end to a second end, a cap 11 releasably attached to the first end of the tube, a threaded bush 22 over a lower portion of the tube, and a splitter 31 with deflector tines 32 connected via arms 33 and 34 via a flange 37 attached around the tube 12 near or at its second end.

A bore in the cap 11 provides an inlet 18 having a smaller cross-sectional area than the cross-sectional area of an outlet 16 (not shown in FIG. 1) of the tube 12. The inlet 18 also has a cross-sectional area less than the cross-sectional area of the internal bore of the tube 12.

Slots 20 extend longitudinally part of the way along a side wall 13 of the tube 12 and function as further inlets to allow fluid (and smaller debris) through, but resist flow of larger particles.

The threaded bush 22 is provided to connect the nozzle apparatus to a pipeline optionally via a reducing bush, as shown in FIGS. 2, 3, 4 and 6.

A solid portion of the tube 12 is provided between the slots 20 and the threaded bush 22. As shown in FIG. 2a, this solid portion is normally, in use, adjacent a reducing bush 26, and serves to position the further inlets generally outwith the reducing bush 26 and into the main body of fluid within a pipeline 40 or joint 30. Whilst certain embodiments (for example the FIG. 5 or 6 embodiment) may not have a solid portion, where present, this positions the further inlets more optimally for certain applications and also provides structural support—noting the tube needs to resist the force of fluid flow through a pipeline. The solid portion also enables for faster production as this portion requires less machining to manufacture.

As further shown in FIG. 2a, an inner chamber 21 of the tube 12 is sized such that the diameter (or other dimension) is larger than the inlet 18 of the cap. Together with the slots 20, this allows full flow through the nozzle apparatus 10 without restriction to the flow in the inner chamber of the nozzle apparatus 10. This region will be free flowing without debris that would normally block the nozzle apparatus's exit orifice since such debris cannot enter, because the slots 20 and the inlet 18 are smaller than the outlet 16.

A channel 23, adjacent the outer threaded bush 22, leads from the chamber 21 to the outlet 16. The channel 23 has the same cross-sectional area compared to the outlet 16 and is therefore a smaller cross-sectional area than the chamber 21 but larger cross sectional area than the inlet 18.

An enlarged cross-sectional view and an enlarged perspective view of the cap 11 are shown in FIG. 2b. The cap 11 is frusto-dome-shaped ˜(dome but with a flat surface) with the inlet 18 at its apex. A circular arrangement of resilient arms 42 extend from the periphery of a main body 41 of the cap 11. The arms have a shoulder 43 at their far end, which is partly tapered inwards. The circular arrangement of the arms is sized such that the arms bend and fit into the inner bore of the tube 12. The tapered shoulders provide a wedge-shape to facilitate said bending, Thus the cap is pressed onto the end of the tube 11, the arms 42 bending and then the shoulders 43 locating into the slots 20 (or other recesses), such that the cap is attached to the tube 12 by way of a snap-fit connection.

The curvature of the dome-shaped cap 11 limits the availability of flat areas of impact (i.e. surfaces at substantially 90 degrees to the direction of flow) for flowing debris and encourages debris in the flow to flow beyond the inlet 18. Any debris flowing in the pipeline is directed around the nozzle apparatus and down past the nozzle apparatus into a debris entrapment area 28 within the pipeline (labelled in FIGS. 3 and 4). The smooth edge/surface of the cap reduces friction of the nozzle apparatus 12 which propels debris away from the inlet 18. The cylindrical shape and/or curved surfaces also provide a smoother flow path of water or delivery fluid for example oil or firefighting foam. The cylindrical and/or curved surfaces further reduce the areas where salt crystallisation can begin allowing a free flow area.

The nozzle apparatus 10 is attached to a pipeline in use. For example in the FIG. 2a illustration, it is attached to a 45 degree elbow fitting 30 via a reducing bush 26. Particles in the medium flowing through the pipeline 40 and into the elbow fitting 30 will not block the nozzle outlet 16 because of the aforementioned features and arrangements. Debris 60, shown in FIG. 4, flows around the cap 11 and if too large to enter the inlet 18 or slots 20, will not enter the nozzle apparatus 12. Given the larger outlet, any debris small enough to proceed through the inlet 18 or slots 20 will not block the larger chamber 21, channel 23 or larger outlet 16.

Fluid continues through the inlet 18, the further inlets 20 into the chamber 21, and then through the channel 23 and out of the outlet 16. The flow contacts the splitter 31 and is distributed outwards by the diffuser tines 32.

As shown in FIG. 2a, the portion of the tube 12 adjacent to the reducing bush 26 is substantially solid. The slots 20 extend in a portion of the tube 12 substantially outwith the reducing bush 26. In this example, 95% of the portion of the tube 12 adjacent to the reducing bush 26 is free from slots 20.

The slots 20 are located substantially within an adjacent ‘debris entrapment area’ 28 between the tube 12 and the inner diameter of the elbow fitting 30. Given the sizes of the inlet 18 and the slots 20, in use, debris flows in the pipeline 40, into the elbow fitting 30, and around and down past the nozzle apparatus 10 into the debris entrapment area 28.

A further embodiment of a nozzle apparatus 110 is shown in FIG. 3.

A ninety degree elbow joint 130 of a pipeline (not shown) is fitted with a nozzle apparatus 110 via a reducing bush 126.

The nozzle apparatus 110 shares many common features as the nozzle apparatus 10 and they have been labelled with the same number except preceded by a “1”. These features will not be described in detail again here.

In contrast to the FIG. 1 embodiment, the further inlets are provided by way of circular apertures 120 on a tube 112 of the nozzle apparatus 110. The circular apertures 120 have a diameter smaller than an outlet 116. Thus, as with the earlier embodiment, debris small enough to pass therethrough, will not be large enough to block the outlet 116.

FIG. 4 shows a further embodiment of a nozzle apparatus 210 connected to a pipeline (not shown) via a T-joint 230. The nozzle apparatus 210 is similar to the nozzle apparatus 10 although its dimensions are somewhat different.

It extends into the pipeline such that an inlet 218 is outwith the centre of the pipeline, that is outwith 15% of a central axis of the pipeline. For example, in a 10 cm inner diameter pipeline which has a central axis at the midway point of the inner diameter, that is 5 cm, the centre is defined by the inner diameter +/−1.5 cm from the central axis with a total diameter of 3 cm.

FIG. 5 shows a perspective exploded view of a further embodiment of a nozzle apparatus 310. This embodiment also shares many similar features as earlier embodiments and these have been labelled with the same number except preceded by a “3”. These features will not be described in detail again here.

Similar to the FIG. 3 embodiment, the FIG. 5 embodiment has circular inlets in a side face 313 of a tube 312. However in contrast to the earlier embodiments, there is no solid portion between a threaded bush 322 and the further inlets 320. Such an embodiment is particularly suitable for weld-o-let fittings.

A similar embodiment is shown in FIG. 6. The nozzle apparatus 410 of FIG. 6 is attached to a pipeline 440 via a weld-o-let fitting 450.

Similar to the FIG. 5 embodiment, there is no solid portion between a threaded bush 422 and the further inlets. In this embodiment however the further inlets are provided by slots 420, similar to the FIG. 1 and FIG. 4 embodiment.

In preferred embodiments the combination of the inlet and the further inlets provides the nozzle apparatus with a K-factor equivalent or greater than the K-factor of an open nozzle without filter, of the same dimensions. The nozzle apparatus 10 thus filters debris from the flow while maintain full bore flow to the nozzle apparatus.

FIG. 7a shows a further embodiment of the cap 511 which includes like parts with the FIG. 2b embodiment and these are not described again in detail. The reference numerals of the like parts share the same latter two digits in both embodiments, but differ in that they are prefixed with a ‘5’ in this embodiment.

The cap 511 comprises a circular inlet 518 at its apex and two slots 519a, 519b. Slot 519a is provided at right-angles to slot 519b, and the two slots 519a, 519b cross each other at the apex of the cap 511. A portion of the slots 519a,519b located adjacent to the circular inlet 518 extend through the cap 511; and a remaining portion of the slots 519a, 519b located furthest from the circular inlet 518 do not extend through the cap 511.

Thus if the central inlet 518 blocks with debris, an additional four flowpaths remain clear, being the slots 519a, 519b on either side of the circular inlet 518.

As with the FIG. 2b embodiment, there is a circular arrangement of resilient arms 542 extending from the periphery of a main body 541 of the cap 511, which comprise a shoulder 543 at their far end. Arms 542 and shoulders 543 are wider than arms 52 and shoulder 53.

FIG. 7b shows the cap 511 attached to a tube 512. The tube 512 functions in the same way as described previously, but in this embodiment it comprises rectangular slots 527 which the shoulders 543 of the cap 511 can engage with to releasably attach the cap 511 to the first end of the tube 512.

In use, the cap 511 and tube 512 are located in a pipeline (not shown in FIG. 7b). Fluid flows from the pipeline into the tube 512 through the slots 519a, 519b and circular inlet 518 in the cap 511.

FIG. 8 shows a perspective view of a further embodiment of a nozzle apparatus 610. This embodiment also shares many similar features as earlier embodiments and these have been labelled with the same number except preceded by a “6”. These features will not be described in detail again here.

The nozzle apparatus 610 is generally similar to that 10 shown in FIG. 1. However, the splitter 631 here comprises a spiral impingement surface, connected to the tube 612 via a flange 637 attached to the tube 612 near or at its second end.

In addition, the cap 611 comprises a circular inlet 618 at its apex and two slots 619a, 619b, similar to that shown in FIGS. 7a and 7b. However, here the cap 611 comprises a screwthread 642, as shown in FIG. 9. It will be appreciated that other embodiments of nozzle apparatus (not shown) may use caps with other attachment means, such as those of FIG. 7a or 1; or an interference fit 732, such as of the cap 711 shown in FIG. 10.

Improvements and modifications may be made, without departing from the scope of the invention.

1. A nozzle apparatus comprising a nozzle and a cap, the nozzle having:
a tube extending from a first end to a second end, the tube having a bore with an internal cross-sectional area;
an inlet to the tube,
an outlet from the tube, the outlet having an outlet cross-sectional area;
a plurality of further inlets in the tube between an outside thereof and the bore;
wherein the cap is added to the inlet of the tube.

2. A nozzle apparatus as claimed in claim 1, wherein the inlet is positioned through the first end of the tube.

3. A nozzle apparatus as claimed in claim 1, wherein the cap is releasable.

4. A nozzle apparatus as claimed in claim 1, wherein the cap is interchangeable.

5. The nozzle apparatus of claim 5, wherein the cap is interchangeable with different caps with different dimensions.

6. A nozzle apparatus as claimed in claim 1, comprising a deflector coaxial with the tube; and a connector, connecting the tube to the deflector.

7. A nozzle apparatus as claimed in claim 6, wherein the tube and connector are formed as a one-piece item.

8. A nozzle apparatus as claimed in claim 1, wherein the cross-sectional area of the cap inlet is less than the outlet cross-sectional area.

9. A nozzle apparatus as claimed in claim 35, wherein the cross-sectional area of the cap inlet is equal to or greater than the outlet cross-sectional area.

10. A nozzle apparatus as claimed in claim 35, wherein at least a portion of the cap inlet is provided in a centre of the cap.

11. A nozzle apparatus as claimed in claim 35, wherein the cap inlet includes at least one slot.

12. A nozzle apparatus as claimed in claim 11, wherein the cap inlet includes at least two slots provided in a cross-arrangement.

13. A nozzle apparatus as claimed in claim 11, wherein a portion of the at least one slot does not extend through the cap.

14. A nozzle apparatus as claimed in claim 36, wherein the nozzle apparatus has cap attachment means including a plurality of resilient arms extending from the cap for engagement in at least one suitably formed recess in the tube.

15. A nozzle apparatus as claimed in claim 14, wherein the arms extend from the cap in a circular arrangement.

16. A nozzle apparatus as claimed in claim 1, wherein the cap is tapered such that the centre of the cap extends longitudinally further than an outer portion of the cap.

17. A nozzle apparatus as claimed in claim 1, wherein the further inlets extend in a portion of the tube for up to 99% of the length of the tube.

18. A nozzle apparatus as claimed in claim 1, wherein the further inlets extend for more than 25% of the length of the tube.

19. A nozzle apparatus as claimed in claim 1, wherein the tube includes two portions having different outer diameters: a first portion, between the inlet and a second portion, and the second portion between the first portion and the outlet, the second portion being a wider diameter portion and having a mounting means comprising a threaded outer body.

20. A nozzle apparatus as claimed in claim 19, wherein the further inlets extend for up to 99% of the length of the first portion of the tube.

21. A nozzle apparatus as claimed in claim 19, wherein the further inlets extend for more than 33% the length of the first portion of the tube.

22. A nozzle apparatus as claimed in claim 1, wherein the bore of the tube includes at least two sections of differing cross-sectional area, a chamber between the inlet and a channel; and the channel between the chamber and the outlet of the tube, wherein the chamber has a larger cross sectional area compared to the channel.

23. A nozzle apparatus as claimed in claim 22, wherein the chamber has a larger cross sectional area compared to a cross-sectional area of the outlet.

24. A nozzle apparatus as claimed in claim 22, wherein the further inlets are provided through the chamber.

25. A nozzle apparatus as claimed in claim 22, wherein at least 80% of the length of the chamber has the same cross-sectional area.

26. A nozzle apparatus as claimed in claim 22, wherein at least 80% of the length of the channel has the same cross-sectional area.

27. A nozzle apparatus as claimed in claim 1, wherein the further inlets have a width which is smaller than a minimum dimension of the outlet from the tube.

28. A nozzle apparatus as claimed in claim 1, wherein there is no more than one outlet to atmosphere.

29. A nozzle apparatus as claimed in claim 1, which is a sprinkler apparatus.

30. A pipeline apparatus comprising the nozzle apparatus as claimed in claim 1 attached to a pipeline.

31. A pipeline apparatus as claimed in claim 30, wherein a reducing bush is used to size and connect the nozzle apparatus into a suitable socket in the pipeline.

32. A pipeline apparatus as claimed in claim 31, wherein the tube is of such a length that it extends beyond the reducing bush.

33. A pipeline apparatus as claimed in claim 31, wherein more than 70% of the area of the tube adjacent the reducing bush is solid, that is without further inlets.

34. A method of using the nozzle apparatus as claimed in claim 1 for firefighting and/or fire containment.

35. A nozzle apparatus as claimed in claim 1 wherein a cap inlet is provided in the cap.

36. A nozzle apparatus as claimed in claim 1, wherein the cap comprises an attachment means for attachment to the inlet to the tube.
